(19) United States
(12) Patent Application Publication
(10) Pub. No.: US 2018/0050897 A1
(43) Pub. Date: Feb. 22, 2018

(54) Waste Beverage Container with Ice Separator

(71) Applicant: Daniel Barry Honeycutt, Salisbury, NC (US)

(72) Inventor: Daniel Barry Honeycutt, Salisbury, NC (US)

(21) Appl. No.: 15/239,738

(22) Filed: Aug. 17, 2016

(51) Int. Cl. B67D 1/16; B01D 29/00; A01G 9/02; A01G 27/00; B65F 1/14; B67D 1/08

(52) U.S. Cl. CPC B67D 1/16; B01D 29/0097; A01G 9/02; A01G 27/00; B65F 2210/176; B65F 1/14; B67D 1/0872; B65F 2001/1489; B65F 2210/132; A01G 27/005

(57) ABSTRACT

The present invention creates a unique method to recover ice from waste beverages. This invention could be especially useful for restaurants. Water reclaimed by the invention could be used to maintain lush vegetation thereby differentiating the restaurant from its competitors in the desert climate. The inventor estimates that about 60 gallons of water per day will be recovered from a typical fast food restaurant with this invention.

### BACKGROUND OF THE INVENTION

Desert locations such as Las Vegas receive as little as four inches of rainfall per year. As such, individuals, businesses, and governments strive to conserve water. Although much effort has been dedicated to conserving water, millions of gallons of water are still wasted by the disposal of post-consumer waste beverage ice.

### BRIEF SUMMARY OF THE INVENTION

The present invention creates a unique method to recover ice from discarded or waste beverages. This present invention could be especially useful for restaurants. Water reclaimed by the invention could be used to maintain lush vegetation thereby differentiating the restaurant from its competitors in the desert climate. The inventor estimates that about 60 gallons of water per day will be recovered from a typical fast food restaurant with this invention.

The present invention recovers water from used melted beverage ice. The used beverage is separated from the ice and directed to the septic system in one embodiment. Benefits of the present invention to restaurants, families, and society are:
1. Relatively clean water that normally would be disposed of in the septic system or dumpster is conserved for additional use such as to water vegetation. Estimates are that 60 gallons of water per day will be conserved from a single typical fast food restaurant.
2. Trash cans and the space around trash cans will be cleaner since less beverage will be contained in the trash cans.
3. Humans will endure less physical strain when transporting trash to the dumpster since the trash cans will contain less beverage, ice, and water. Estimates are that the total load of all trash in a typical restaurant will be reduced by 500 lbs per day.
4. There will be less insects around dumpsters and trash cans since there will be less sugary beverage contained in them.
5. Environmentally conscience consumers will be less likely to leave restaurants or places of business with a drink in hand thereby promoting better health for the consumer and a cost savings for the restaurant.
6. Fosters good will for the restaurant since conserving water is admired by most people.
7. Restaurants and homes in desert areas can maintain lush vegetation thereby differentiating them from other restaurants and homes that do not make use of the present invention.

### BRIEF DESCRIPTION OF THE DRAWINGS

Drawings depicting one embodiment of the invention are included in FIG. 1 and FIG. 2.

FIG. 1 is a perspective view of the invention depicting the externally visible components of the invention for one embodiment.

FIG. 2 is a perspective view of the invention with the container hidden (indicated by dashed lines) so that internal components of the invention are visible. FIG. 2 also depicts the drain pipe 201 that leads to the septic system.

### DETAILED DESCRIPTION OF THE INVENTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

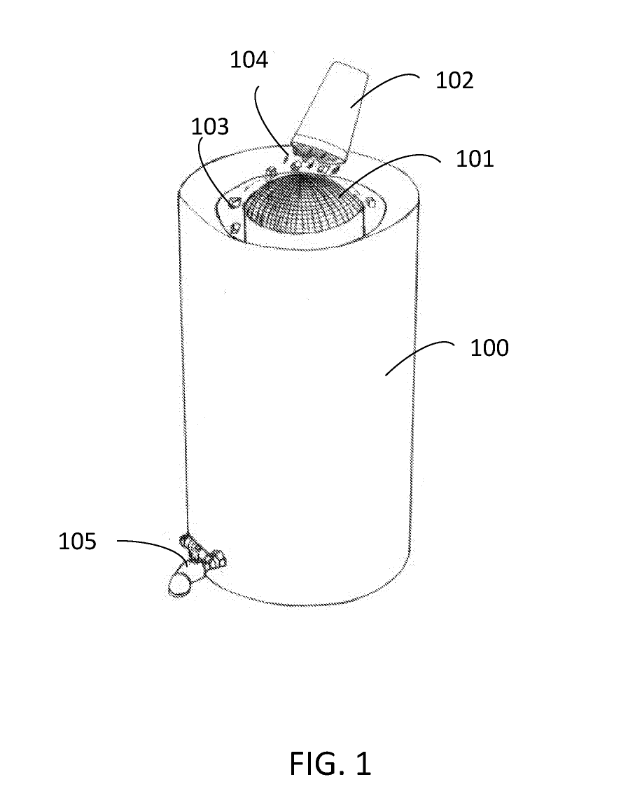

FIG. 1 depicts an embodiment of the waste beverage container. Waste beverage 104 and waste ice 103 poured from a cup 102 are separated from one another by the strainer 101. The waste beverage 104 flows through the strainer and most of the waste ice 103 is deflected by the strainer 101. The holes in the strainer 101 are large enough to allow waste beverage to easily flow through the strainer 101, but the holes in the strainer 101 are small enough to prevent most of the waste ice from flowing through the strainer 101. The exterior of the ice container 100 is shown in FIG. 1. A water spigot 105 which can be used to release water from the ice container 100 is shown in FIG. 1.

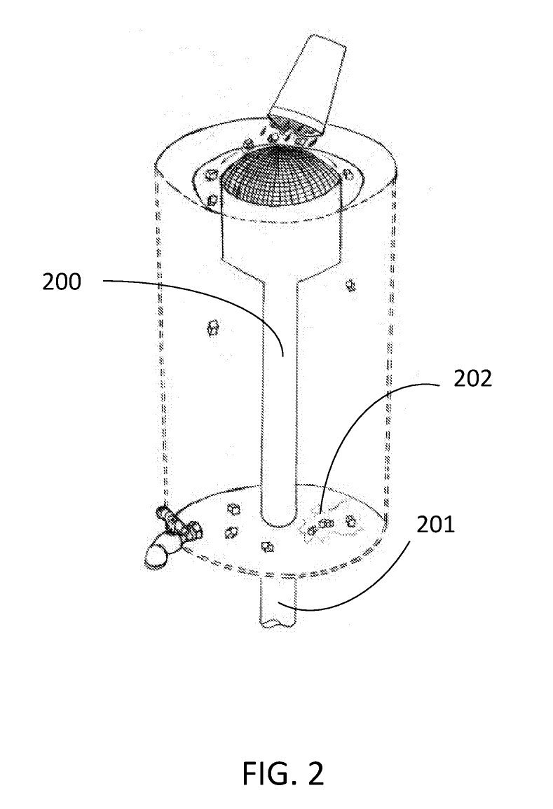

FIG. 2 depicts the embodiment of FIG. 1 with the wall of the ice container 100 hidden. The drain pipe 200 directs the waste beverage to the septic system. The bottom of the drain pipe 201 which further directs the waste beverage to the septic system is also shown in FIG. 2. Melting ice and water 202 is stored in the container.

The strainer 101 depicted in FIG. 1 allows waste beverage to easily flow through and into the drain pipe (FIG. 2, 202) while most of the waste ice slides down the strainer 101 and into the container 100. In the embodiment depicted in FIG. 1, the strainer 101 is constructed from a flat sheet of wire mesh formed into a dome shape. One skilled in the art will recognize that there are many forming methods whereby a flat sheet of wire mesh may be formed into a domed shape. One skilled in the art will also recognize that the domed screen 101 functions as a strainer. Furthermore, one skilled in the art will recognize that many different types of strainers may be used in place of the domed screen in various embodiments. In some embodiments of the present invention, the strainer 101 formed from flat wire mesh may be replaced with perforated metal or perforated plastic formed into a dome shape. One skilled in the art will recognize that there are many forming methods whereby flat sheets of metal or plastic may be perforated and formed into a dome shape. Waste beverage will flow through the perforations in the metal or plastic dome shape while waste ice will be deflected off the metal or plastic dome shaped and directed into the container 100. One skilled in the art will recognize many different methods whereby many different types of strainers may be constructed and used in the present invention. Furthermore, one skilled in the art will recognize that a dome shaped strainer may be replaced with a flat strainer (not shown) mounted to the top of the drain pipe at an inclined angle. Waste beverage will flow through the angled strainer while waste ice will deflect and slide off of the angled strainer and into the container 100. One skilled in the art will recognize that there are many different methods whereby many different type of strainers may be attached to the drain pipe 200.

FIG. 2, depicts the drain pipe 200 which directs the waste beverage to the septic system. In various embodiments the drain pipe may be tapered as depicted in FIG. 2, or not tapered. One skilled in the art will recognize that the drain pipe 200 may be constructed of many different types of materials such as metal or plastic. One skilled in the art will also recognize that the drain pipe 200 may direct the waste beverage to the septic system or to any other desired location. One skilled in the art will recognize that at the location where the drain pipe exits the container 100 must be sealed so that water will not leak around the drain pipe.

FIG. 1 depicts the container 100 used for holding the melting ice. One skilled in the art will recognize that the container 100 may be of various sizes, shapes, and materials.

FIG. 1 depicts a water spigot 105 which may be used to release or hold the water in the container 100 as desired. One skilled in the art will recognize that there are many different types of devices or methods that may be used to hold or release the water from the container 100. In certain embodiments a spigot 105 or valve is not used but instead the bottom of the container 100 is perforated and the water is allowed to freely flow out of the container into a desired area such as a natural area or garden.

The present invention could be located in various places in or around a home, restaurant, or business. In one embodiment the present invention is located adjacent to the normal waste basket inside the restaurant. In another embodiment the present invention is located outside the restaurant.

To the knowledge of the inventor, no other waste beverage container exists that separates the waste beverage from the waste ice. In most cases, the waste beverage and waste ice are disposed of in a garbage can along with the disposable cup. In some cases the waste beverage and waste ice are poured into a sink drain and routed to the septic system. As previously described herein, the present invention reclaims the waste ice and makes use of the melted ice (water) for other purposes such as irrigating vegetation.

What is claimed:

1. A waste beverage container equipped with a device to separate waste beverage from waste ice.

2. The waste beverage container of claim 1, where in the separated waste beverage and ice are used for any purpose.

3. The waste beverage container of claim 1, wherein the waste ice is stored in the waste beverage container.

4. The waste beverage container of claim 1, wherein the waste beverage is routed to the septic system.

5. The waste beverage container of claim 1, wherein the waste beverage is stored in a container within the waste beverage container.

6. The waste beverage container of claim 1, wherein the waste beverage is routed to a natural area for consumption by insects.

7. The waste beverage container of claim 1, wherein the waste beverage is diluted with water from another source and used for irrigation of vegetation.

8. The waste beverage container of claim 3, wherein the water from the melted stored ice is used to irrigate vegetation.

9. The waste beverage container of claim 3, wherein the water from the melted stored ice is used to for cleaning.

10. The waste beverage container of claim 3, wherein the ice is melted by a heater

11. The waste beverage container of claim 3, wherein the separating device is a sloped perforated surface where the apertures of the perforated surface are dimensioned to maximize the traversal of waste beverage into the apertures and minimize the traversal of waste ice into the apertures and the slope of the perforated surface is dimensioned to maximize the traversal of waste ice into the container.

12. The waste beverage container of claim 3, wherein the melted ice is dispersed with a pump.

13. The waste beverage container of claim 3, wherein the melted ice traverses through a water spigot.

14. The waste beverage container of claim 3, wherein the melted ice traverses through holes in the bottom of the waste beverage container and is used for any purpose.

15. The waste beverage container of claim 3, wherein the waste beverage container is stored in a natural area.

16. The waste beverage container of claim 7 or claim 8, wherein the waste beverage container is combined with a potted plant.

17. The waste beverage container of claim 1 combined with a drink dispenser to separate waste beverage from waste ice poured into the waste area of the drink dispenser.

18. The waste beverage container of claim 1, wherein warm air is routed through the container and cooled by the stored ice and the cool air is used to cool building space.

19. The waste beverage container of claim 3, wherein the ice melts due to the ambient temperature being higher than the temperature of the ice.
